(19) United States
(12) Patent Application Publication
(10) Pub. No.: US 2026/0113537 A1
(43) Pub. Date: Apr. 23, 2026

(54) IMAGE CAPTURING APPARATUS, CONTROL METHOD, AND STORAGE MEDIUM

(71) Applicant: CANON KABUSHIKI KAISHA, Tokyo (JP)

(72) Inventor: TETSUYA HADA, Tokyo (JP)

(21) Appl. No.: 19/351,677

(22) Filed: Oct. 7, 2025

(30) Foreign Application Priority Data
Oct. 17, 2024 (JP) 2024-182170

(51) Int. Cl. H04N 23/667; H04N 23/62

(52) U.S. Cl. CPC H04N 23/667; H04N 23/62

(57) ABSTRACT

There is provided an image capturing apparatus including a first operation member having an unpressed state, a half-pressed state, and a fully-pressed state. A storage unit stores a setting value of a shooting setting for still images and a setting value of a shooting setting for moving images. A control unit performs control such that while an image shot using the setting value for still images is being displayed on a display unit, in response to the first operation member transitioning from the unpressed state to the half-pressed state, display on the display unit is switched to display of an image shot using the setting value for moving images, and in response to the first operation member transitioning to the fully-pressed state, recording of a moving image shot using the setting value for moving images is started.

### BACKGROUND

### Field of the Technology

The present disclosure relates to image capturing apparatus, a control method, and a storage medium.

### Description of the Related Art

Digital cameras that start shooting a moving image when a button for starting moving image shooting is pressed while a still image shooting mode is set are known.

Japanese Patent Laid-Open No. 2009-219020 discloses a technology for performing peaking display in response to a shutter button being half pressed while shooting a moving image, and then shooting a still image in response to the shutter button being fully pressed.

Heretofore, a technology for switching to a moving image shooting mode in response to a half-press operation of an operation member while shooting in a still image shooting mode is not known.

### SUMMARY

The present disclosure, in at least one aspect, provides a technology for switching to a moving image shooting mode in response to a half-press operation of an operation member while shooting in a still image shooting mode.

According to a first aspect of the present disclosure, there is provided an image capturing apparatus comprising: a first operation member having an unpressed state, a half-pressed state, and a fully-pressed state; a storage unit configured to store a setting value of a shooting setting for still images and a setting value of a shooting setting for moving images; and a control unit configured to perform control such that: while an image shot using the setting value for still images is being displayed on a display unit, in response to the first operation member transitioning from the unpressed state to the half-pressed state, display on the display unit is switched to display of an image shot using the setting value for moving images; and in response to the first operation member transitioning to the fully-pressed state, recording of a moving image shot using the setting value for moving images is started.

According to a second aspect of the present disclosure, there is provided a control method executed by an image capturing apparatus, wherein the image capturing apparatus comprises: a first operation member having an unpressed state, a half-pressed state, and a fully-pressed state; and a storage unit configured to store a setting value of a shooting setting for still images and a setting value of a shooting setting for moving images, the control method comprising: performing control such that: while an image shot using the setting value for still images is being displayed on a display unit, in response to the first operation member transitioning from the unpressed state to the half-pressed state, display on the display unit is switched to display of an image shot using the setting value for moving images; and in response to the first operation member transitioning to the fully-pressed state, recording of a moving image shot using the setting value for moving images is started.

According to a third aspect of the present disclosure, there is provided a non-transitory computer-readable storage medium which stores a program for causing a computer of an image capturing apparatus to execute a control method, wherein the image capturing apparatus comprises: a first operation member having an unpressed state, a half-pressed state, and a fully-pressed state; and a storage unit configured to store a setting value of a shooting setting for still images and a setting value of a shooting setting for moving images, the control method comprising: performing control such that: while an image shot using the setting value for still images is being displayed on a display unit, in response to the first operation member transitioning from the unpressed state to the half-pressed state, display on the display unit is switched to display of an image shot using the setting value for moving images; and in response to the first operation member transitioning to the fully-pressed state, recording of a moving image shot using the setting value for moving images is started.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing the external appearance of a camera 100.

FIG. 2 is a block diagram showing an example configuration of the camera 100 and an interchangeable lens unit 150.

FIG. 3 is a flowchart of processing that is executed by the camera 100 in relation to operation of an AF-ON button 83 when the camera 100 is set to a still image shooting mode.

FIGS. 4A to 4C are diagrams illustrating a specific example of the processing of step S304.

FIG. 5 is a flowchart of processing for assigning starting of moving image shooting to a function of the AF-ON button 83 for the still image shooting mode.

FIG. 6 is a flowchart showing example processing that is performed when an AE lock button 77 is operated in the case where the camera 100 does not accept other button operations while a first AF switch 84 is being pressed.

FIG. 7 is a flowchart of processing that is executed by the camera 100 in relation to operation of the AF-ON button 83 when the camera 100 is set to a moving image shooting mode.

FIGS. 8A to 8C are diagrams illustrating a specific example of the processing of step S703.

FIG. 9 is a diagram showing a display unit 28 after moving image shooting has started.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

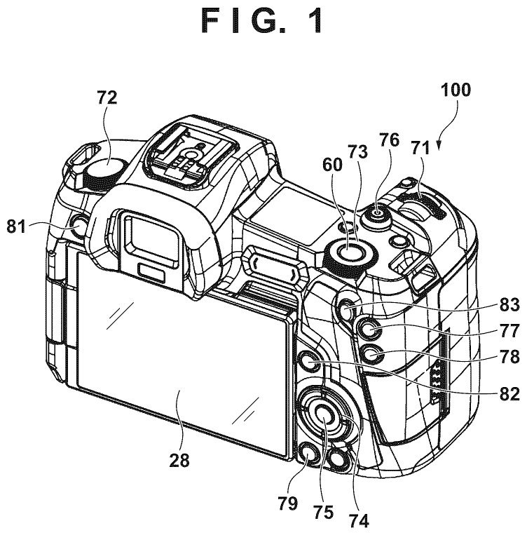

FIG. 1 is a diagram showing the external appearance of a camera 100. A mode changing switch 60 is an operation member for switching between various modes. A main electronic dial 71 is a rotary operation member. By rotating the main electronic dial 71, the user can change setting values such as shutter speed and aperture and perform other operations. A power switch 72 is an operation member for powering the camera 100 on and off.

A sub-electronic dial 73 is a rotary operation member. By rotating the sub-electronic dial 73, the user can move a selection frame (cursor), advance through images, and the like. A 4-way directional keypad 74 is constituted such that up, down, left, and right portions thereof can be pressed. The camera 100 performs processing that depends on the portion of the 4-way directional keypad 74 that is pressed.

A SET button 75 is a push button and is mainly used to finalize a selected item and the like. A moving image button 76 is used to instruct starting and stopping of moving image shooting (recording). The AE lock button 77 is a push button. By pressing the AE lock button 77 while in a shooting standby state, the user is able to fix an exposure state.

A zoom button 78 is an operation button for switching a zoom mode on and off in live view display (LV display) of a shooting mode. By operating the main electronic dial 71 after turning the zoom mode on, the user can zoom a live view image (LV image) in and out. In a playback mode, the zoom button 78 functions as an operation button for performing operations on the playback image such as zooming in and increasing the magnification rate.

A play button 79 is an operation button for switching between the shooting mode and a playback mode. The user is able to transition the camera 100 to the playback mode by pressing the play button 79 while in the shooting mode, and to display the latest image on a display unit 28, among the images recorded on a storage medium 185.

A menu button 81 is a push button that is used to perform an instruction operation for displaying a menu screen. When the menu button 81 is pressed, a menu screen in which various settings can be configured is displayed on the display unit 28. The user is able to intuitively configure various settings, using the menu screen displayed on the display unit 28 and the 4-way directional keypad 74 and SET button 75.

An INFO button 82 is a push button that is used to switch the information displayed on the display unit 28. When the INFO button 82 is pressed, the information displayed on the display unit 28 is switched.

The AF-ON button 83 is a push button with a two-stage mechanism. It is possible to assign functions to both a half-press and a full-press of the AF-ON button 83. For example, in the case where metering and AF start are assigned to the half-press and eye AF is assigned to the full-press, the user is able to perform metering and AF processing on the subject by half pressing the AF-ON button 83 while in the shooting standby state, and then to again perform metering and AF processing on the subject whose eye has been detected by fully pressing the AF-ON button 83.

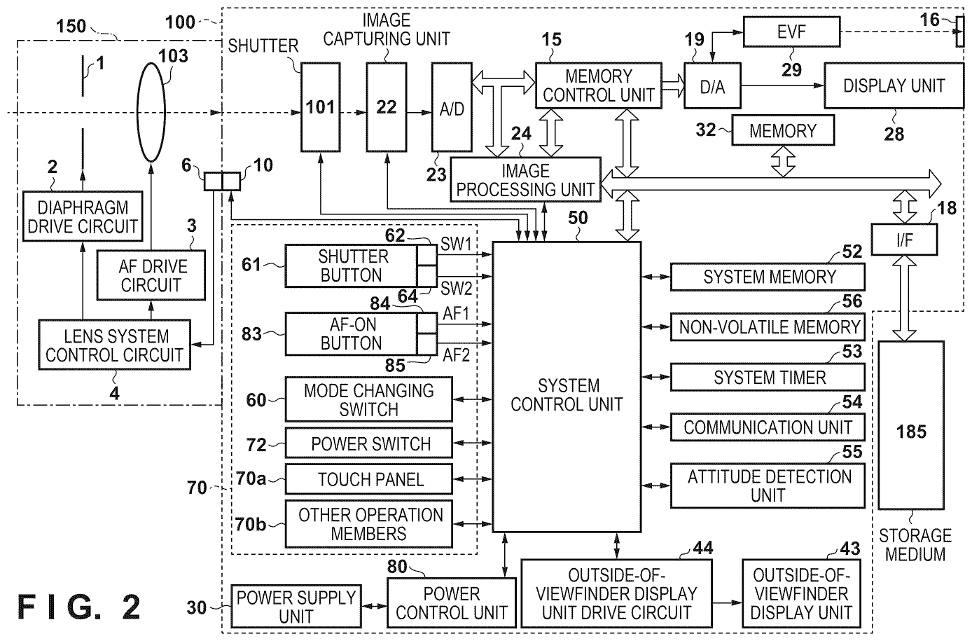

FIG. 2 is a block diagram showing an example configuration of the camera 100 and the interchangeable lens unit 150. A lens 103 is usually constituted by multiple lenses but is simplified to only one lens in FIG. 2. A communication terminal 6 is a communication terminal for a lens unit 150 to communicate with the camera 100, and a communication terminal 10 is a communication terminal for the camera 100 to communicate with the lens unit 150. The lens unit 150 communicates with a system control unit 50 via these communication terminals 6 and 10. A lens system control circuit 4 inside the lens unit 150 controls a diaphragm 1 through a diaphragm drive circuit 2. Also, the lens system control circuit 4 focuses by varying the position of the lens 103 via an AF drive circuit 3.

A shutter 101 is a focal plane shutter that is able to freely control the exposure time of an image capturing unit 22 in accordance with control by the system control unit 50. The image capturing unit 22 is an image capturing element (image sensor) constituted by a CCD element, a CMOS element, or the like that converts optical images into electrical signals. The image capturing unit 22 may have an image capturing plane phase detection sensor that outputs defocus amount information to the system control unit 50. An A/D converter 23 converts analog signals output from the image capturing unit 22 into digital signals.

An image processing unit 24 performs predetermined processing (pixel interpolation, resizing processing such as reduction, color conversion processing, etc.) on data from the A/D converter 23 or data from a memory control unit 15. Also, the image processing unit 24 performs predetermined computational processing using captured image data, and the system control unit 50 performs exposure control and ranging control based on the computation results obtained by the image processing unit 24. Through-the-lens (TTL) autofocus (AF) processing, auto-exposure (AE) processing, flash pre-emission (EF) processing, etc., are thereby performed. The image processing unit 24 further performs predetermined computational processing using the captured image data, and performs TTL automatic white balance (AWB) processing based on the obtained computation results.

Output data from the A/D converter 23 is written to a memory 32 via the image processing unit 24 and the memory control unit 15. Alternatively, the output data from the A/D converter 23 is written to the memory 32 via the memory control unit 15 and not via the image processing unit 24. The memory 32 stores image data obtained by the image capturing unit 22 and converted into digital data by the A/D converter 23, and image data for display on the display unit 28 and an electronic viewfinder (EVF 29). The memory 32 has sufficient storage capacity to store a predetermined number of still images or a predetermined duration of moving images and audio.

The memory 32 also serves as a memory (video memory) for image display. A D/A converter 19 converts the data for image display stored in the memory 32 into an analog signal and supplies the analog signal to the display unit 28 and the EVF 29. The image data for display written to the memory 32 is thus displayed by the display unit 28 and the EVF 29 via the D/A converter 19. The display unit 28 and the EVF 29 are displays such as an LCD, organic EL display, or the like, and perform display that depends on the analog signal from the D/A converter 19. Live view display (LV) can be performed by the digital signal A/D converted by the A/D converter 23 and stored in the memory 32 being converted into an analog signal by the D/A converter 19 and sequentially transferred to the display unit 28 or the EVF 29 and displayed. Hereinafter, images displayed in the live view display will be called live view images (LV images). The user is able to view images displayed on the EVF 29 via an eyepiece unit 16.

The system control unit 50 is a control unit constituted by at least one processor and/or at least one circuit and controls the entire camera 100. The system control unit 50 realizes the various processing of the embodiment described below, by executing programs recorded in a non-volatile memory 56. The system control unit 50 also performs display control by controlling the memory 32, the D/A converter 19, the display unit 28, the EVF 29, and the like.

A system memory 52 is a RAM, for example. The system control unit 50 extracts constants and variables for operation of the system control unit 50, as well as programs read out from the non-volatile memory 56 to the system memory 52.

The non-volatile memory 56 is an electrically erasable and recordable memory, and is an EEPROM, for example. The constants for operation of the system control unit 50, programs, operation member disposition information and the like are recorded to the non-volatile memory 56. Programs as referred to here are programs for executing various flowcharts described later in the present embodiment.

A system timer 53 is a clocking unit that measures time for use in various controls and time of a built-in clock.

A communication unit 54 transmits and receives various data such as video signals, audio signals, and commands to and from external devices connected to the camera 100 by wireless or cable. The communication unit 54 can also connect to a wireless Local Area Network (LAN) and the Internet. The communication unit 54 can also communicate with external devices via Bluetooth or Bluetooth Low Energy. The communication unit 54 is capable of transmitting images (including LV images) captured by the image capturing unit 22 and images recorded on the storage medium 185, and is able to receive image data and various other information from external devices.

An attitude detection unit 55 detects the attitude of the camera 100 relative to the direction of gravity. The system control unit 50 is capable of determining whether an image shot with the image capturing unit 22 is an image shot with the camera 100 held horizontally or vertically, based on the attitude detected by the attitude detection unit 55. The system control unit 50 is capable of performing various processing on an image captured by the image capturing unit 22, including adding orientation information that depends on the attitude detected by the attitude detection unit 55 to an image file of the image and recording the image in a rotated state. An acceleration sensor, a gyro sensor, or the like can be used as the attitude detection unit 55. It is also possible to detect movement of the camera 100 (whether the camera is being panned, tilted, lifted, held stationary, etc.) using the acceleration sensor or gyro sensor serving as the attitude detection unit 55.

An outside-of-viewfinder display unit 43 displays various setting values of the camera 100, including shutter speed and aperture, via an outside-of-viewfinder display unit drive circuit 44.

A power control unit 80 is constituted by a battery detection circuit, a DC-DC converter, a switch circuit for switching the block that receives power, and the like, and performs detection of whether a battery is mounted, the type of battery, the remaining battery level, and the like. Also, the power control unit 80 controls the DC-DC converter based on the detection result and instructions of the system control unit 50, and supplies the required voltage to various parts including the storage medium 185 for the required period. A power supply unit 30 is constituted by a primary battery such as alkaline battery or a lithium battery or a secondary battery such as a NiCd battery, an NiMH battery, or a Li battery, an AC adapter, and the like.

A storage medium I/F 18 is an interface with the storage medium 185, which is a memory card, a hard disk, or the like. The storage medium 185 is a storage medium such as a memory card for recording images that have been shot, and is constituted by a semiconductor memory, a magnetic disk, or the like.

An operation unit 70 is an input unit that accepts operations from the user (user operations), and is constituted by a plurality of operation members used to input various operation instructions into the system control unit 50. As shown in FIG. 2, the operation unit 70 includes a shutter button 61, the AF-ON button 83, the mode changing switch 60, the power switch 72, a touch panel 70a, other operation members 70b, and the like. The other operation members 70b include the main electronic dial 71, the sub-electronic dial 73, the 4-way directional keypad 74, the SET button 75, the moving image button 76, the AE lock button 77, the zoom button 78, the play button 79, and the menu button 81.

The shutter button 61 is provided with a first shutter switch 62 and a second shutter switch 64. The first shutter switch 62 is turned on by the shutter button 61 being operated partway, that is, a so-called half-press (shooting preparation instruction), and generates a first shutter switch signal SW1. The system control unit 50 starts shooting preparation operations (shooting preparation processing) such as autofocus (AF) processing, automatic exposure (AE) processing, automatic white balance (AWB) processing, and flash pre-emission (EF) processing, in response to the first shutter switch signal SW1.

The second shutter switch 64 is turned on by the shutter button 61 being operated completely, that is, a so-called full-press (shooting instruction), and generates a second shutter switch signal SW2. The system control unit 50 starts a series of shooting processing operations from signal readout from the image capturing unit 22 to writing of the captured image to the storage medium 185 as an image file, in response to the second shutter switch signal SW2. Note that it is assumed that the system control unit 50 performs the above operations, in response to the first shutter switch signal SW1 and the second shutter switch signal SW2, in the case of a still image shooting mode. In other words, the system control unit 50 performs the shooting preparation operations, in response to receiving the first shutter switch signal SW1, in a first setting state described later. Then, in response to thereafter receiving the second shutter switch signal SW2, the system control unit 50 records a still image shot with setting values for still images. However, a configuration may be adopted in which different operations are executed according to the operation on the shutter button 61, in the case of a moving image shooting mode. For example, a configuration may be adopted in which, in the case of the moving image shooting mode, or in other words, a second setting state described later, shooting (recording) of a moving image is started, in response to the second shutter switch signal SW2, and shooting (recording) of the moving image is stopped in response to receiving the second shutter switch signal SW2 again during moving image shooting (recording).

The AF-ON button 83 is provided with a first AF switch 84 and a second AF switch 85. The first AF switch 84 is turned on by the AF-ON button 83 being operated partway, that is, a so-called half-press, and generates a first AF switch signal AF1. The second AF switch 85 is turned on by the AF-ON button 83 being operated completely, that is, a so-called full-press, and generates a second AF switch signal AF2. The AF-ON button 83 can be assigned a function selected by the user.

The mode changing switch 60 switches the operating mode of the camera 100 (system control unit 50) to one of the still image shooting mode, the moving image shooting mode, the playback mode, and the like. The modes included in the still image shooting mode include an auto shooting mode, an auto scene discrimination mode, a manual mode, an aperture priority mode (Av mode), a shutter speed priority mode (Tv mode), a program AE mode (P mode), and the like. Also, there are various scene modes that are shooting scene-specific shooting settings, custom modes, and the like. With the mode changing switch 60, the user is able to directly switch to any of these modes. Alternatively, a configuration may be adopted in which the user displays a list screen of the shooting modes on the display unit 28 with the mode changing switch 60, and then selectively switch to one of the displayed modes using another operation member. Similarly, the moving image shooting mode may also include a plurality of modes.

The touch panel 70a is a touch sensor that detects various touch operations on the display surface of the display unit 28 (operation surface of touch panel 70a). The touch panel 70a and the display unit 28 can be constituted integrally. For example, the touch panel 70a is configured such that light transmittance does not interfere with display on the display unit 28, and is attached on an upper layer of the display surface of the display unit 28. Input coordinates on the touch panel 70a are then mapped to display coordinates on the display surface of the display unit 28. A graphical user interface (GUI) that allows the user to feel as though he or she is directly operating the screen displayed on the display unit 28 can thereby be provided.

Here, shooting parameters that are used by the camera 100 at the time of shooting will be described. The non-volatile memory 56 stores a setting value for still images and a setting value for moving images for each of one or more shooting parameters. Examples of the one or more shooting parameters include white balance, ISO sensitivity, aspect ratio, AF frame, and the like. The system memory 52 stores current setting values of the shooting parameters.

When the operating mode of the camera 100 is set to the still image shooting mode by a user operation on the mode changing switch 60, the system control unit 50 reads out the still image setting values of the shooting parameters from the non-volatile memory 56 and stores the setting values in the system memory 52. A still image setting value is thereby set for each of the one or more shooting parameters, and the live view image shot with the still image setting values is displayed on the display unit 28.

When the operating mode of the camera 100 is set to the moving image shooting mode by a user operation on the mode changing switch 60, the system control unit 50 reads out the moving image setting values of the shooting parameters from the non-volatile memory 56 and stores the setting values in the system memory 52. A moving image setting value is thereby set for each of the one or more shooting parameters, and the live view image shot with the moving image setting values is displayed on the display unit 28.

Also, the user is able to change the setting values of the shooting parameters stored in the non-volatile memory 56. The method of changing the setting values is not specifically limited. As an example, the user is able to change the setting values for the type of image (still image or moving image) corresponding to the current shooting mode, by operating the operation unit 70 when the operating mode of the camera 100 is the still image shooting mode or the moving image shooting mode. For example, consider the case where “auto” is stored in the non-volatile memory 56 as the setting value of white balance for still images. In this case, when the operating mode of the camera 100 is set to the moving image shooting mode, “auto” is stored in the system memory 52 as the current setting value of white balance. In this state, the user is able to change the current white balance setting value from “auto” to “daylight” by operating the sub-electronic dial 73. At this time, the white balance setting for still images stored in the non-volatile memory 56 is also changed from “auto” to “daylight”.

### Processing Relating to Operation of AF-ON Button 83 in Still Image Shooting Mode

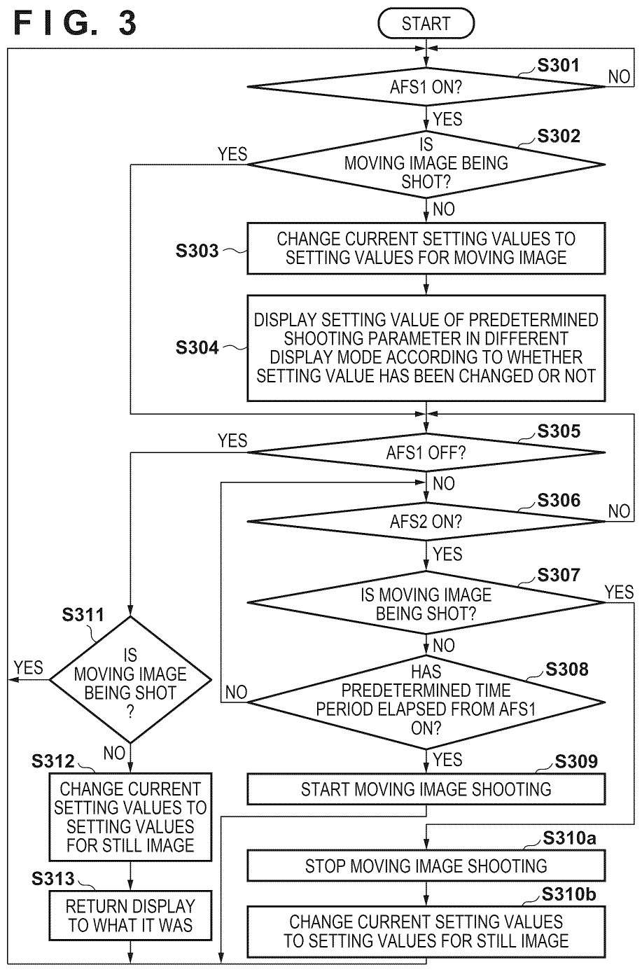

FIG. 3 is a flowchart of processing that is executed by the camera 100 in relation to operation of the AF-ON button 83 when the camera 100 is set to the still image shooting mode. The processing of the steps of this flowchart is realized by the system control unit 50 extracting a program recorded in the non-volatile memory 56 to the system memory 52 and executing the program, unless specifically noted otherwise. In the description of this flowchart, it is assumed that starting of moving image shooting is assigned as a function of the AF-ON button 83 for the still image shooting mode.

The processing of this flowchart starts when the operating mode of the camera 100 is the still image shooting mode. Accordingly, the setting state of the shooting parameters at the start of the processing of this flowchart is the first setting state (a state in which a still image setting value is set for each of one or more shooting parameters, and a live view image shot with still image setting values is displayed on display unit 28).

In step S301, the system control unit 50 determines whether the first AF switch 84 is being pressed (i.e., whether AF-ON button 83 is in half-pressed state). The system control unit 50 repeats the determination of step S301 until the first AF switch 84 is pressed. When the first AF switch 84 is pressed, the processing proceeds to step S302.

In step S302, the system control unit 50 determines whether the camera 100 is shooting a moving image. If a moving image is being shot, the processing proceeds to step S305, and if a moving image is not being shot, the processing proceeds to step S303.

In step S303, the system control unit 50 reads out the moving image setting values of the shooting parameters from the non-volatile memory 56 and stores the setting values in the system memory 52. The setting state of the shooting parameters thereby transitions to the second setting state (state in which a moving image setting value is set for each of one or more shooting parameters, and a live view image shot with moving image setting values is displayed on display unit 28). That is, the system control unit 50 performs setting control such that the setting state of the one or more shooting parameters transitions from the first setting state to the second setting state.

In step S304, the system control unit 50 determines, for a predetermined shooting parameter, whether the current setting value corresponding to the second setting state is the same as the setting value corresponding to the first setting state before the processing of step S303. If the second setting value is different from the first setting value, the system control unit 50 displays the second setting value in a first display mode. If the second setting value is the same as the first setting value, the system control unit 50 displays the second setting value in a second display mode different from the first display mode or refrains from displaying the second setting value. Note that the predetermined shooting parameter described here is not limited to one shooting parameter, and the system control unit 50 may perform similar processing for each of two or more shooting parameters.

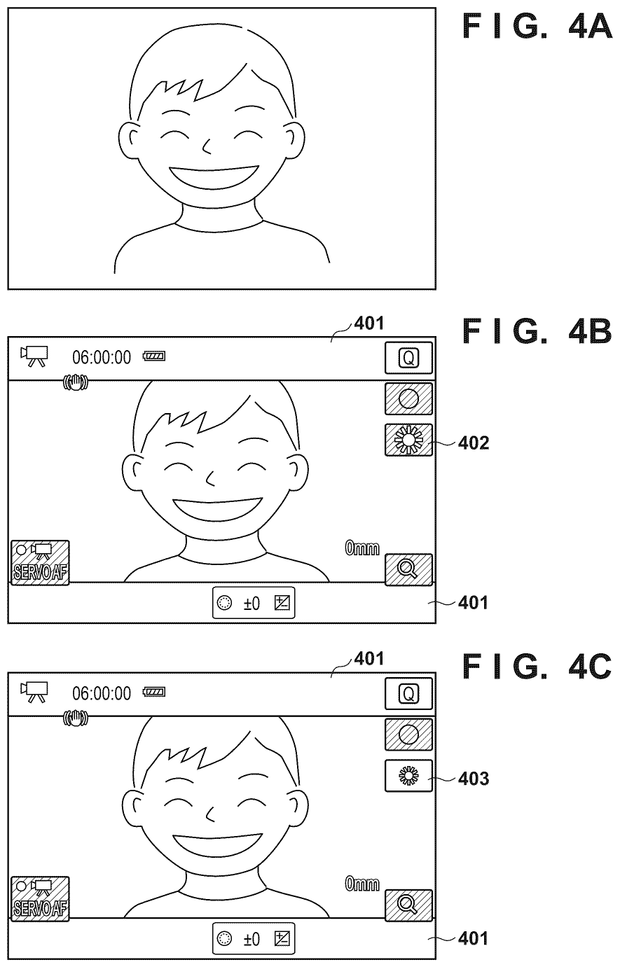

A specific example of the processing of step S304 will be described here with reference to FIGS. 4A to 4C. Here, it is assumed that the predetermined shooting parameter is white balance. FIG. 4A is a diagram showing the display unit 28 before the processing of step S303, with a live view image in the still image shooting mode (viewing angle (aspect ratio) is 3:2) being displayed on the display unit 28. That is, in FIG. 4A, a live view image shot using the still image setting values is being displayed. At this time, it is assumed that the white balance is “auto”. FIG. 4B is a diagram showing the display unit 28 after the processing of step S304, with a live view image for moving image shooting (viewing angle (aspect ratio) is 16:9) being displayed. At this time, it is assumed that the white balance is “daylight”.

In FIG. 4B, reference numeral 401 denotes display of a black band, which indicates that this area is not recorded during moving image shooting. Reference numeral 402 denotes an icon that represents the white balance setting value, and indicates that the white balance for daylight is set. In this example, the current white balance setting value is different from the setting value before the processing of step S303. Thus, in step S304, the current white balance setting value is displayed in the mode shown by reference number 402 in FIG. 4B.

Here, consider the case where the white balance for still images and the white balance for moving images are both “daylight”. In this case, in step S304, the current white balance setting value is displayed in the mode shown by reference numeral 403 in FIG. 4C. Alternatively, the system control unit 50 may refrain from displaying the current white balance setting value.

In the examples of FIGS. 4B and 4C, the display size of the white balance setting value in the first display mode (size of mark within icon 402) is larger than the display size of the white balance setting value in the second display mode (size of mark within icon 403). Also, in the first display mode, the background of the icon 402 is highlighted by diagonal lines, whereas in the second display mode, the background of the icon 403 does not include diagonal lines.

In this way, in the present embodiment, the setting value (“daylight” in the example of FIGS. 4B and 4C) is displayed in a different display mode, according to whether or not the white balance setting value has changed in response to the AF-ON button 83 transitioning from the unoperated state to the half-pressed state. Alternatively, a configuration may be adopted in which the setting value is not displayed, if the white balance setting value has not changed in response to the AF-ON button 83 transitioning from the unoperated state to the half-pressed state. Thus, the user is able to easily recognize whether the white balance setting has changed in response to the AF-ON button 83 transitioning from the unoperated state to the half-pressed state.

Similarly, in the case where the predetermined shooting parameter is aspect ratio, the system control unit 50 may display the setting value in a different display mode, according to whether or not the setting value of aspect ratio has changed in response to the AF-ON button 83 transitioning from the unoperated state to the half-pressed state. For example, the system control unit 50 may display an icon including the characters “16:9” in a different display mode, according to whether or not the aspect ratio setting value has changed in response to the AF-ON button 83 transitioning from the unoperated state to the half-pressed state. Alternatively, a configuration may be adopted in which the system control unit 50 refrains from displaying the setting value, if the aspect ratio setting value has not changed in response to the AF-ON button 83 transitioning from the unoperated state to the half-pressed state.

Note that, in the example of FIG. 4A, the white balance setting value is not displayed before the AF-ON button 83 transitions from the unoperated state to the half-pressed state. However, the system control unit 50 may display the white balance setting value when the live view display shown in FIG. 4A is being performed. The display mode of the white balance setting value at this time is not specifically limited.

Different shooting parameters are sometimes used for still image shooting and moving image shooting. However, with conventional technology, it is not easy for the user to recognize whether or not the shooting parameters have changed when shooting a different type of image from the type of image corresponding to the current shooting mode (e.g., when starting moving image shooting while still image shooting mode is set).

In contrast, in the present embodiment, it is possible to assist the user to recognize whether or not the setting value of a predetermined shooting parameter has changed, when shooting a different type of image from the type of image corresponding to the current shooting mode.

In step S305, the system control unit 50 determines whether the first AF switch 84 has been released. If the first AF switch 84 has been released, the processing proceeds to step S311, and if the first AF switch 84 has not been released, the processing proceeds to step S306.

In step S306, the system control unit 50 determines whether the second AF switch 85 is being pressed (i.e., whether AF-ON button 83 is in fully-pressed state). If the second AF switch 85 is being pressed, the processing proceeds to step S307, and, if not, the processing returns to step S305.

In step S307, the system control unit 50 determines whether the camera 100 is shooting a moving image. If a moving image is being shot, the processing proceeds to step S310, and if a moving image is not being shot, the processing proceeds to step S308.

In step S308, the system control unit 50 determines whether a predetermined time period (e.g., 1 second) has elapsed from when the first AF switch 84 was pressed. If the predetermined time period has elapsed, the processing proceeds to step S309, and, if not, the processing returns to step S306.

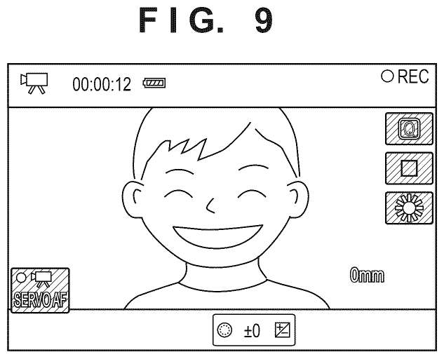

In step S309, the system control unit 50 starts moving image shooting. FIG. 9 shows the display unit 28 after starting moving image shooting. Since step S308 is before step S309, if the AF-ON button 83 transitions from the half-pressed state to the fully-pressed state before the half-pressed state of the AF-ON button 83 has continued for the predetermined time period, the system control unit 50 refrains from shooting a moving image in the second setting state for moving images. Thus, the user is able to check the screen of FIG. 4B or FIG. 4C for at least the predetermined time period before moving image shooting starts. Accordingly, as a result of the processing of step S308, the user's chances of recognizing whether or not the setting value of the predetermined shooting parameter (e.g., white balance) has changed can be improved.

In step S310a, the system control unit 50 stops the moving image shooting. Step S310a is processing that is performed when moving image shooting is started in step S309 and is in progress. In other words, when moving image shooting is started by the AF-ON button 83 being fully pressed, and then the AF-ON button 83 is fully pressed again, the processing of step S310a for stopping the moving image shooting is executed.

In step S310b, the system control unit 50 reads out the still image setting values of the shooting parameters from the non-volatile memory 56 and stores the setting values in the system memory 52. The setting state of the shooting parameters thereby transitions to the first setting state (state in which still image setting value is set for each of one or more shooting parameters, and live view image shot with still image setting values is displayed on display unit 28).

In step S311, the system control unit 50 determines whether the camera 100 is shooting a moving image. If a moving image is being shot, the processing returns to step S301, and if a moving image is not being shot, the processing proceeds to step S312.

The processing of step S312 is similar to the processing of step S310b.

In step S313, the system control unit 50 returns display on the display unit 28 to the state before the processing of step S304. At this time, display on the display unit 28 transitions from the display of FIG. 4B to the display of FIG. 4A.

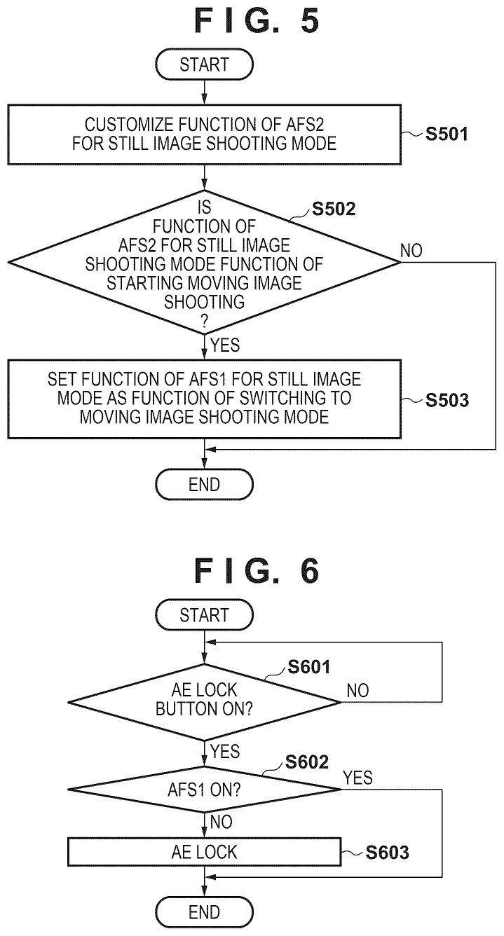

FIG. 5 is a flowchart of processing for assigning starting of moving image shooting to a function of the AF-ON button 83 for the still image shooting mode. The processing of the steps of this flowchart is realized by the system control unit 50 extracting a program recorded in the non-volatile memory 56 to the system memory 52 and executing the program, unless specifically noted otherwise.

In step S501, the system control unit 50 performs processing for customizing the function of the second AF switch 85 for the still image shooting mode, in accordance with a user instruction given via the operation unit 70.

In step S502, the system control unit 50 determines whether the function of the second AF switch 85 customized in step S501 is the function of starting moving image shooting. If the function of the second AF switch 85 is the function of starting moving image shooting, the processing proceeds to step S503, and, if not, the processing of this flowchart ends.

In step S503, the system control unit 50 assigns the function of switching to the moving image shooting mode to the function of the first AF switch 84 for the still image shooting mode. Furthermore, in the present embodiment, in step S503, the function of switching to the still image shooting mode is assigned to the function of the first AF switch 84 for the moving image shooting mode, and the function of still image shooting is automatically assigned to the function of the second AF switch 85 for the moving image shooting mode. At this time, it is desirable to inform the user that the still image shooting function has been assigned to the function of the AF-ON button 83 for moving image shooting.

FIG. 6 is a flowchart showing example processing that is performed when the AE lock button 77 is operated in the case where the camera 100 does not accept other button operations while the first AF switch 84 is being pressed. The processing of the steps of this flowchart is realized by the system control unit 50 extracting a program recorded in the non-volatile memory 56 to the system memory 52 and executing the program, unless specifically noted otherwise.

In step S601, the system control unit 50 determines whether the AE lock button 77 is being pressed. The system control unit 50 repeats the determination on step S601 until the AE lock button 77 is pressed. When the AE lock button 77 is pressed, the processing proceeds to step S602.

In step S602, the system control unit 50 determines whether the first AF switch 84 is being pressed (i.e., whether AF-ON button 83 is in half-pressed state). If the first AF switch 84 is being pressed, the processing of this flowchart ends, and if the first AF switch 84 is not being pressed, the processing proceeds to step S603.

In step S603, the system control unit 50 performs AE lock processing.

As described above, according to the present embodiment, the camera 100 is provided with the AF-ON button 83 having an unpressed state, a half-pressed state, and a fully-pressed state. Also, the camera 100 is provided with the non-volatile memory 56 that stores a setting value for still images and a setting value for moving images for each of one or more shooting parameters. The camera 100, in the still image shooting mode, is in the first setting state in which the still image setting values are set, and, in response to the AF-ON button 83 transitioning from the unpressed state to the half-pressed state in this state, performs control to transition to the second setting state in which the moving image setting values are set. In the case where, for a predetermined setting item (e.g., white balance) among the setting items, the second setting value (e.g., “daylight”) corresponding to the second setting state differs from the first setting value (e.g., “auto”) corresponding to the first setting state, the camera 100 displays the second setting value in the first display mode while the AF-ON button 83 is in the half-pressed state. Also, in the case where the second setting value (e.g., “daylight”) is the same as the first setting value (e.g., “daylight”), the camera 100 performs control to display the second setting value in the second display mode different from the first display mode or to refrain from displaying the second setting value, while the AF-ON button 83 is in the half-pressed state. The camera 100 shoots a moving image in the second setting state, in response to the AF-ON button 83 transitioning from the half-pressed state to the fully-pressed state.

In this way, in the still image shooting mode, the setting value is displayed in a different display mode, according to whether or not the setting value of the predetermined shooting parameter has changed in response to the AF-ON button 83 transitioning from the unoperated state to the half-pressed state. Accordingly, with the present embodiment, the shooting mode can be temporarily changed by operating the AF-ON button 83. Also, it is possible to assist the user to recognize whether or not the setting value of the predetermined shooting parameter has changed, when shooting a different type of image from the type of image corresponding to the current shooting mode.

### Processing Relating to Operation of AF-ON Button 83 in Moving Image Shooting Mode

In the camera 100 of the present embodiment, moving image shooting is performed by operating the AF-ON button 83 in the still image shooting mode, whereas, in the moving image shooting mode, still image shooting is performed by operating the AF-ON button 83.

Note that, with the camera 100 of the present embodiment, it is assumed that, in the case where starting of moving image shooting is assigned as a function of the AF-ON button 83 for the still image shooting mode, the still image shooting function is automatically assigned as a function of the AF-ON button 83 for moving image shooting.

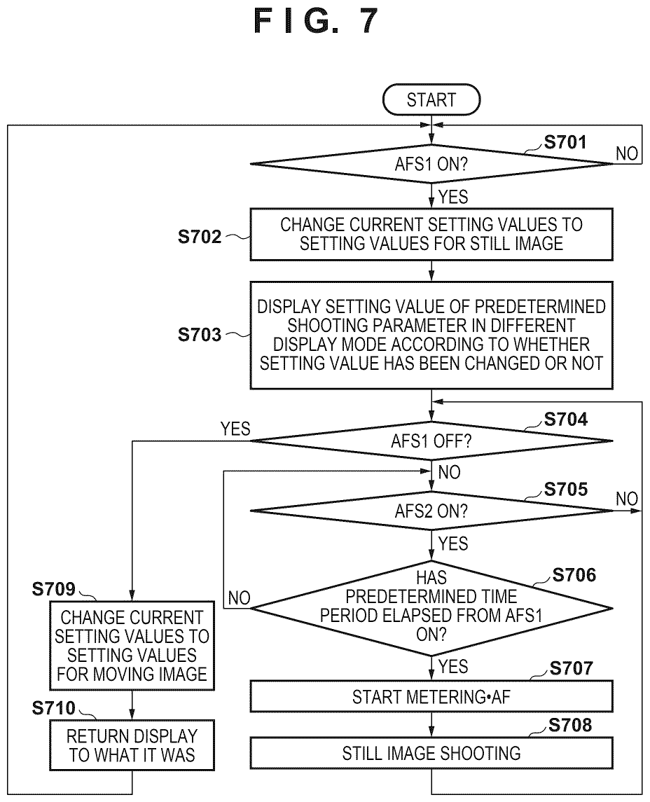

FIG. 7 is a flowchart of processing that is executed by the camera 100 in relation to operation of the AF-ON button 83 in the moving image shooting mode in the case where starting of moving image shooting is assigned as a function of the AF-ON button 83 for the still image shooting mode. The processing of the steps of this flowchart is realized by the system control unit 50 extracting a program recorded in the non-volatile memory 56 to the system memory 52 and executing the program, unless specifically noted otherwise. As mentioned above, in this flowchart, still image shooting is assigned as a function of the AF-ON button 83 for the moving image shooting mode.

The processing of this flowchart starts when the operating mode of the camera 100 is set to the moving image shooting mode. Accordingly, the setting state of the shooting parameters at the start of the processing of this flowchart is the second setting state (state in which moving image setting value is set for each of one or more shooting parameters, and live view image shot with moving image setting values is displayed on display unit 28).

In step S701, the system control unit 50 determines whether the first AF switch 84 is being pressed (i.e., whether AF-ON button 83 is in half-pressed state). The system control unit 50 repeats the determination of step S701 until the first AF switch 84 is pressed. When the first AF switch 84 is pressed, the processing proceeds to step S702.

In step S702, the system control unit 50 reads out the still image setting values of the shooting parameters from the non-volatile memory 56 and stores the setting values in the system memory 52. The setting state of the shooting parameters thereby transitions to the first setting state (state in which still image setting value is set for each of one or more shooting parameters, and live view image shot with still image setting values is displayed on display unit 28). That is, the system control unit 50 performs setting control such that the setting state of the one or more shooting parameters transitions from the second setting state to the first setting state.

The processing of step S703 is similar to the processing of step S304.

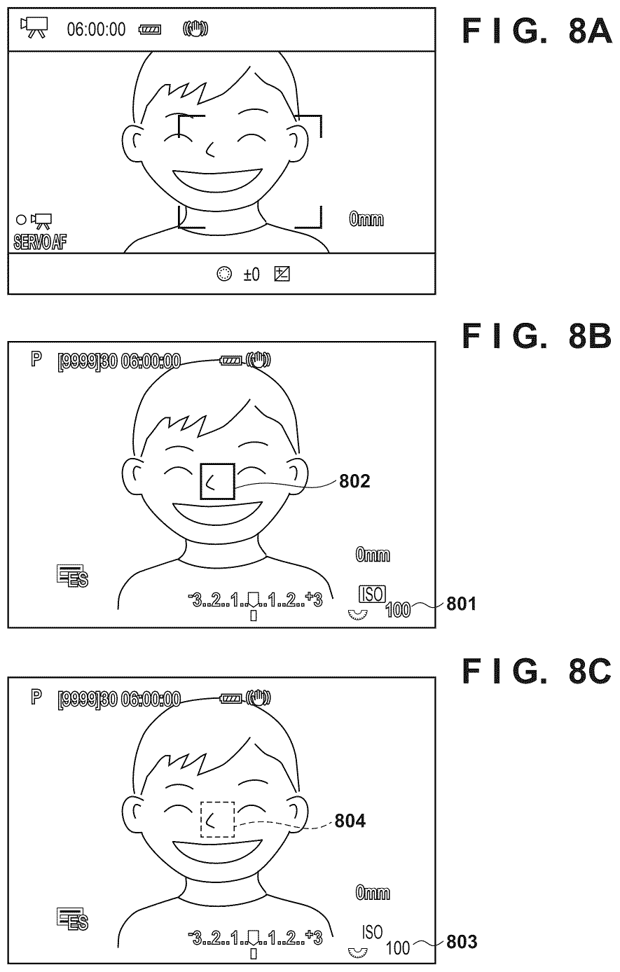

A specific example of the processing of step S703 will be described here with reference to FIGS. 8A to 8C. Here, it is assumed that the predetermined shooting parameters include ISO sensitivity and AF frame. FIG. 8A is a diagram showing the display unit 28 before the processing of step S702, with a live view image in the moving image shooting mode (viewing angle (aspect ratio) is 16:9) being displayed. FIG. 8B is a diagram showing the display unit 28 after the processing of step S703, with a live view image for still image shooting (viewing angle (aspect ratio) is 3:2) being displayed. Here, it is assumed that, as a result of the processing of step S702, the setting value of ISO sensitivity changes from “auto” to “100” and the setting value of AF frame changes from “zone” to “single point”. Reference numeral 801 denotes an icon that represents the ISO sensitivity setting value, and shows that “100” is set as the ISO sensitivity. Reference numeral 802 is a frame that represents the AF frame setting value, and indicates a single point AF frame.

Here, consider the case where the ISO sensitivity for moving images and the ISO sensitivity for still images are both “100”, and the AF frame for moving images and the AF frame for still images are both “single point”. In this case, the current setting values of ISO sensitivity and AF frame are displayed in a different display mode from the case of FIG. 8B, as shown by reference numerals 803 and 804 in FIG. 8C. Alternatively, the system control unit 50 may refrain from displaying the current setting values of either or both of ISO sensitivity and AF frame.

In step S704, the system control unit 50 determines whether the first AF switch 84 has been released. If the first AF switch 84 has been released, the processing proceeds to step S709, and if the first AF switch 84 has not been released, the processing proceeds to step S705.

In step S705, the system control unit 50 determines whether the second AF switch 85 is being pressed (i.e., whether AF-ON button 83 is in fully-pressed state). If the second AF switch 85 is being pressed, the processing proceeds to step S706, and, if not, the processing returns to step S704.

In step S706, the system control unit 50 determines whether a predetermined time period (e.g., 1 second) has elapsed from when the first AF switch 84 was pressed. If the predetermined time period has elapsed, the processing proceeds to step S707, and, if not, the processing returns to step S705.

In step S707, the system control unit 50 starts metering and AF.

In step S708, the system control unit 50 performs still image shooting processing. Thereafter, the processing returns to step S704.

In step S709, the system control unit 50 reads out the moving image setting values of the shooting parameters from the non-volatile memory 56 and stores the setting values in the system memory 52. The setting state of the shooting parameters thereby transitions to the second setting state (state in which moving image setting value is set for each of one or more shooting parameters, and live view image shot with moving image setting values is displayed on display unit 28).

In step S710, the system control unit 50 returns display on the display unit 28 to the state before the processing of step S703. At this time, the display on the display unit 28 transitions from the display of FIG. 8B to the display of FIG. 8A.

As described above, according to the present embodiment, the camera 100 is provided with the AF-ON button 83 having an unpressed state, a half-pressed state, and a fully-pressed state. Also, the camera 100 is provided with the non-volatile memory 56 that stores a setting value for still images and a setting value for moving images for each of one or more shooting parameters. Also, it is assumed that, in the case where starting of moving image shooting is assigned as a function of the AF-ON button 83 for the still image shooting mode, the still image shooting function is automatically assigned as a function of the AF-ON button 83 for moving image shooting. Thus, the camera 100, in the moving image shooting mode, performs control to transition to the first setting state in which the still image setting values are set, in response to the AF-ON button 83 transitioning from the unpressed state to the half-pressed state in the second setting state in which the moving image setting values are set. In the case where, for a predetermined setting item (e.g., ISO sensitivity) among the setting items, the first setting value (e.g., “100”) corresponding to the first setting state is different from the second setting value (e.g., “auto”) corresponding to the second setting state, the camera 100 displays the first setting value in the first display mode, while the AF-ON button 83 is in the half-pressed state. Also, in the case where the first setting value (e.g., “100”) is the same as the second setting value (e.g., “100”), the camera 100 performs control to display the first setting value in the second display mode different from the first display mode or to refrain from displaying the second setting value, while the AF-ON button 83 is in the half-pressed state. The camera 100 shoots a still image in the first setting state, in response to the AF-ON button 83 transitioning from the half-pressed state to the fully-pressed state.

Accordingly, even in the moving image shooting mode, the shooting mode can be temporarily changed by operating the AF-ON button 83, similarly to in the still image shooting mode. Also, it is possible to assist the user to recognize whether or not the setting value of the predetermined shooting parameter has changed, when shooting a different type of image from the type of image corresponding to the shooting mode.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-182170, filed Oct. 17, 2024, which is hereby incorporated by reference herein in its entirety.

What is claimed is:

1. An image capturing apparatus comprising:
a first operation member having an unpressed state, a half-pressed state, and a fully-pressed state;
a storage unit configured to store a setting value of a shooting setting for still images and a setting value of a shooting setting for moving images; and
a control unit configured to perform control such that:
while an image shot using the setting value for still images is being displayed on a display unit, in response to the first operation member transitioning from the unpressed state to the half-pressed state, display on the display unit is switched to display of an image shot using the setting value for moving images; and
in response to the first operation member transitioning to the fully-pressed state, recording of a moving image shot using the setting value for moving images is started.

2. The image capturing apparatus according to claim 1, further comprising:
a second operation member,
wherein the control unit performs control such that, while an image shot using the setting value for still images is being displayed on the display unit, in response to the second operation member being operated, a still image shot using the setting value for still images is recorded.

3. The image capturing apparatus according to claim 2,
wherein the second operation member is a shutter button having an unpressed state, a half-pressed state, and a fully-pressed state, and
the control unit executes shooting preparation processing, in a case where the second operation member transitions to the half-pressed state, while an image shot using the setting value for still images is being displayed on the display unit, and performs control such that a still image shot using the setting value for still images is recorded, in a case where the second operation member transitions to the fully-pressed state.

4. The image capturing apparatus according to claim 1,
wherein the control unit performs control such that, in response to the first operation member transitioning from the half-pressed state to the unpressed state, display on the display unit is switched from display of an image shot using the setting value for moving images to display of an image shot using the setting value for still images.

5. The image capturing apparatus according to claim 1,
wherein, after recording of a moving image shot using the setting value for moving images is started in response to the first operation member transitioning to the fully-pressed state, the control unit performs control such that, in response to recording of the moving image being stopped, display on the display unit is switched from display of an image shot using the setting value for moving images to display of an image shot using the setting value for still images.

6. The image capturing apparatus according to claim 5,
wherein the control unit performs control such that, in response to the first operation member transitioning to the fully-pressed state, an image shot using the setting value for moving images is displayed on the display unit and recording of a moving image shot using the setting value for moving images is started, and such that, in response to the first operation member again transitioning to the fully-pressed state after recording of the moving image is started, recording of the moving image is stopped and an image shot using the setting value for still images is displayed on the display unit.

7. The image capturing apparatus according to claim 1,
wherein the setting value of the shooting setting for still images and the setting value of the shooting setting for moving images stored in the storage unit are setting values set by a user, and
the image capturing apparatus further comprises:
a changing unit configured to change the setting value of the shooting setting for still images and the setting value of the shooting setting for moving images stored in the storage unit, according to a user operation.

8. The image capturing apparatus according to claim 7,
wherein the storage unit stores the setting value for still images and the setting value for moving images for a same shooting setting item, and
the control unit performs control such that, while an image shot using the setting value for still images is displayed on the display unit, in response to the first operation member transitioning from the unpressed state to the half-pressed state, display on the display unit is switched from display of the image shot using the setting value for still images to display of an image shot using the setting value for moving images.

9. The image capturing apparatus according to claim 1,
wherein the control unit performs control such that, while an image shot using the setting value for still images is displayed on the display unit, in response to the first operation member transitioning from the unpressed state to the half-pressed state, display on the display unit is switched to display of an image shot using the setting value for moving images that has been stored in the storage unit prior to transition to the half-pressed state.

10. The image capturing apparatus according to claim 1,
wherein the shooting setting for still images and the shooting setting for moving images are settings relating to an aspect ratio.

11. The image capturing apparatus according to claim 1, further comprising:
a switching unit configured to switch an operating mode of the image capturing apparatus among a plurality of modes including a still image shooting mode and a moving image shooting mode, according to a mode switching operation,
wherein the control unit displays an image shot using the setting value for moving images on the display unit, in a case where the first operation member is in the half-pressed state, even in the still image shooting mode, and, in response to the first operation member transitioning to the fully-pressed state, starts recording of a moving image shot using the setting value for moving images.

12. The image capturing apparatus according to claim 1,
wherein the control unit performs control such that, while an image shot using the setting value for moving images is displayed on the display unit, in response to the first operation member transitioning from the unpressed state to the half-pressed state, display on the display unit is switched to display of an image shot using the setting value for still images, and such that, in response to the first operation member thereafter transitioning to the fully-pressed state, shooting processing using the setting value for still images is executed.

13. The image capturing apparatus according to claim 1,
wherein, while an image shot using the setting value for still images is displayed on the display unit, in response to the first operation member transitioning from the unpressed state to the half-pressed state, the control unit
displays the setting value for moving images in a first display mode, in a case where the setting value for moving images differs from the setting value for still images, and
displays the setting value for moving images in a second display mode different from the first display mode or refrains from displaying the setting value for moving images, in a case where the setting value for moving images is same as the setting value for still images.

14. The image capturing apparatus according to claim 13,
wherein the first display mode is a display mode in which display is highlighted more than in the second display mode.

15. The image capturing apparatus according to claim 14,
wherein a display size of the setting value for moving images in the first display mode is larger than a display size of the setting value for moving images in the second display mode.

16. The image capturing apparatus according to claim 1,
wherein, in a case where the first operation member transitions from the half-pressed state to the fully-pressed state before the half-pressed state of the first operation member has continued for a predetermined time period, the control unit refrains from starting recording of a moving image shot using the setting value for moving images.

17. The image capturing apparatus according to claim 1, further comprising:
a third operation member; and
a processing unit configured to execute predetermined processing in response to the third operation member being operated, wherein, in a case where the third operation member is operated while the first operation member is in the half-pressed state, the processing unit refrains from executing the predetermined processing.

18. A control method executed by an image capturing apparatus, wherein the image capturing apparatus comprises:
a first operation member having an unpressed state, a half-pressed state, and a fully-pressed state; and
a storage unit configured to store a setting value of a shooting setting for still images and a setting value of a shooting setting for moving images,
the control method comprising:
performing control such that:
while an image shot using the setting value for still images is being displayed on a display unit, in response to the first operation member transitioning from the unpressed state to the half-pressed state, display on the display unit is switched to display of an image shot using the setting value for moving images; and
in response to the first operation member transitioning to the fully-pressed state, recording of a moving image shot using the setting value for moving images is started.

19. A non-transitory computer-readable storage medium which stores a program for causing a computer of an image capturing apparatus to execute a control method, wherein the image capturing apparatus comprises:
a first operation member having an unpressed state, a half-pressed state, and a fully-pressed state; and
a storage unit configured to store a setting value of a shooting setting for still images and a setting value of a shooting setting for moving images,
the control method comprising:
performing control such that:
while an image shot using the setting value for still images is being displayed on a display unit, in response to the first operation member transitioning from the unpressed state to the half-pressed state, display on the display unit is switched to display of an image shot using the setting value for moving images; and
in response to the first operation member transitioning to the fully-pressed state, recording of a moving image shot using the setting value for moving images is started.
